(19) United States
(12) Patent Application Publication
(10) Pub. No.: US 2016/0239207 A1
(43) Pub. Date: Aug. 18, 2016

(54) STORAGE CONTROL APPARATUS AND STORAGE CONTROL METHOD

(71) Applicant: FUJITSU LIMITED, Kawasaki-shi (JP)

(72) Inventor: Atsushi Takakura, Kawasaki (JP)

(73) Assignee: FUJITSU LIMITED, Kawasaki (JP)

(21) Appl. No.: 14/989,394

(22) Filed: Jan. 6, 2016

(30) Foreign Application Priority Data
Feb. 13, 2015 (JP) 2015-026241

(51) Int. Cl. G06F 3/06; G06F 12/08

(52) U.S. Cl. CPC G06F 3/0604; G06F 3/0631; G06F 3/0632; G06F 3/0683; G06F 12/0802; G06F 2212/60

(57) ABSTRACT

A storage unit stores management information for managing whether data is written in a first storage area. When writing write target data and a check code corresponding to the write target data to a second storage area, which is a continuous storage area including an address next to an end address of the first storage area specified based on the management information, the control unit updates the management information such that the first storage area includes the second storage area by changing the end address of the first storage area to an end address of the second storage area. Further, when reading read target data from inside the first storage area specified based on the management information, the control unit reads a check code corresponding to the read target data, together with the read target data.

### CROSS-REFERENCE TO RELATED APPLICATION

This application is based upon and claims the benefit of priority of the prior Japanese Patent Application No. 2015-026241, filed on Feb. 13, 2015, the entire contents of which are incorporated herein by reference.

### FIELD

The embodiments discussed herein are related to a storage control apparatus and a storage control method.

### BACKGROUND

As there has been a growing demand for storage apparatuses to ensure data integrity, various functions for ensuring data integrity have been provided. One of such functions is the T10 Data Integrity Field (T10-DIF) function. The T10-DIF function has been standardized by the American National Standards Institute (ANSI), and is a function for preventing silent data corruption that occurs unexpectedly and makes data recovery extremely difficult.

Before the introduction of the T10-DIF function, each of a storage apparatus, a server, and a transmission line was used to hold check codes and protect data, thereby ensuring data integrity. Therefore, reassignment of check codes was needed. On the other hand, when both a storage apparatus and a server support the T10-DIF function, the storage apparatus and the server share common check codes, and thus it possible to extend the range of data protection.

See, for example, Japanese Laid-open Patent Publication No. 2006-344223 and Japanese Laid-open Patent Publication No. 2010-079686.

However, a storage apparatus supporting the T10-DIF function needs to set all bits to “1” in a check code corresponding to an unwritten area and returns the check code to a server.

Accordingly, when a READ command is received from the server, the storage apparatus determines on a per storage area basis whether the READ command is for a written area or for an unwritten area. Such a determination operation on a per storage area basis causes overhead in responding to the READ command, resulting in a reduction in the reading performance.

### SUMMARY

According to one aspect of the invention, there is provided a storage control apparatus that controls access to a predetermined storage area in a storage device. The storage control apparatus includes: a memory configured to store management information for managing whether data is written in a first storage area, the first storage area being continuous from a start address of a logical volume; and a processor configured to perform a procedure. The procedure includes: when writing write target data and a check code corresponding to the write target data to a second storage area in units of predetermined areas, the second storage area being continuous and including an address next to an end address of the first storage area specified based on the management information, updating the management information such that the first storage area includes the second storage area by changing the end address of the first storage area to an end address of the second storage area; when reading read target data from inside the first storage area specified based on the management information, reading a check code corresponding to the read target data, together with the read target data; and when reading read target data from outside the first storage area specified based on the management information, determining on a per predetermined area basis whether data is written, reading a check code corresponding to the read target data, together with the read target data, from a storage area where data is written, and setting a predetermined value in a check code corresponding to a storage area where no data is written.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the configuration of a storage control apparatus according to a first embodiment;

FIG. 2 illustrates an example of the configuration of a storage system according to a second embodiment;

FIG. 3 illustrates an example of the data structure supported by the T10-DIF function according to the second embodiment;

FIG. 4 illustrates an example of the configuration of a storage apparatus according to the second embodiment;

FIG. 5 is a block diagram illustrating an example of the configuration of the processing functions of a controller module according to the second embodiment;

FIG. 6 illustrates an example of the data structure of an LU write management table according to the second embodiment;

FIG. 7 illustrates an example of management-area update writing and management-area non-update writing according to the second embodiment;

FIG. 8 illustrates an example of intra-management-area reading and extra-management-area reading according to the second embodiment;

FIG. 9 is a flowchart of an LU write management table initialization process according to the second embodiment;

FIG. 10 is a flowchart of a WRITE command receiving process according to the second embodiment; and

FIG. 11 is a flowchart of a READ command receiving process according to the second embodiment.

### DESCRIPTION OF EMBODIMENTS

Several embodiments will be described below with reference to the accompanying drawings, wherein like reference numerals refer to like elements throughout.

### (a) First Embodiment

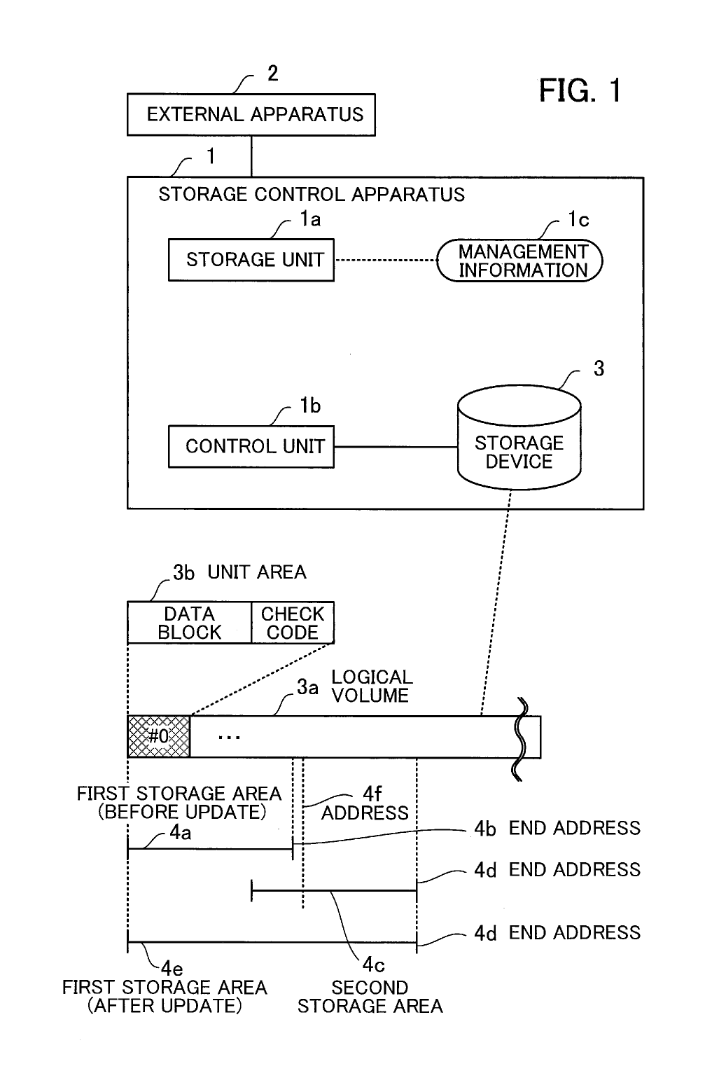

First, a storage control apparatus 1 of a first embodiment will be described with reference to FIG. 1. FIG. 1 illustrates an example of the configuration of the storage control apparatus 1 according to the first embodiment.

The storage control apparatus 1 controls access to a predetermined storage area in a storage device 3. For example, the storage control apparatus 1 receives an access request from an external apparatus 2 such as a host and a server, and controls access to the storage device 3. Examples of access requests include a READ command (read request) and a WRITE command (write request).

The storage device 3 has a physical storage area, and includes one or more solid state drives (SSDs) or hard disk drives (HDDs). The storage device 3 may be a drive enclosure (DE) that accommodates SSDs or HDDs. The storage device 3 allocates a physical storage area to a logical volume 3a.

The storage control apparatus 1 includes a storage unit 1a and a control unit 1b. The storage unit 1a stores management information 1c. The storage unit 1a may be, for example, a random access memory (RAM) or the like. The management information 1c is information for managing whether data is written in a first storage area. The first storage area is a storage area where data is written continuously from the start address of the logical volume 3a. The end address is an address indicating the end of the first storage area. For example, a first storage area (before update) 4a is a storage area that is continuous from a start address Logical Block Addressing (LBA) #0 to an end address 4b.

When writing write target data and a check code corresponding to the write target data to a second storage area in units of predetermined areas (unit areas 3b), the control unit 1b updates the management information 1c such that the first storage area includes the second storage area. In doing so, the control unit 1b updates the end address of the first storage area to the end address of the second storage area, thereby making the first storage area include the second storage area.

The storage control apparatus 1 writes write target data and a check code corresponding to the write target data to the second storage area when, for example, the storage control apparatus 1 receives from the external apparatus 2 a WRITE command to the second storage area. That is, the control unit 1b writes write target data corresponding to the WRITE command and a check code corresponding to the write target data to the second storage area. The logical volume 3a includes one or more unit areas 3b. Each unit area 3b includes a data block and a check code. The data block is an area that stores data (for example, user data). The check code is a code used for detecting an error in the data stored in the data block.

The second storage area is a continuous storage area including an address next to the end address of the first storage area specified based on the management information 1c. For example, a second storage area 4c is a continuous storage area whose start address is within the range of the first storage area (before update) 4a, whose end address 4d is outside the range of the first storage area (before update) 4a, and which includes an address 4f next to the end address 4b of the first storage area (before update) 4a. For example, the control unit 1b updates the management information 1c such that a first storage area (after update) 4e includes the second storage area 4c by changing the end address 4b of the first storage area (before update) 4a to the end address 4d.

Further, when reading read target data from inside the first storage area specified based on the management information 1c, the control unit 1b reads a check code corresponding to the read target data, together with the read target data. Since the check code stored in the first storage area is written in the manner described above and thus corresponds to the data in the first storage data, the control unit 1b may simply read the check code.

On the other hand, when reading read target data from outside the first storage area specified based on the management information 1c, the control unit 1b determines on a per predetermined area (unit area 3b) basis whether data is written. For example, the control unit 1b may determine whether data is written, by referring to metadata.

The control unit 1b reads a check code corresponding to the read target data, together with the read target data, from the storage area where data is written (a unit area 3b for which a determination is made that data is written). Since the check code stored outside the first storage area corresponds to the written data, the control unit 1b may simply read the check code.

Further, the control unit 1b sets a predetermined value in a check code corresponding to the storage area where no data is written (a unit area 3b for which a determination is made that no data is written). Since the check code stored outside the first storage area is not guaranteed to correspond to data in the unwritten area, the control unit 1b sets a predetermined value in the check code. The predetermined value that is set in the check code is a value determined in advance. For example, the predetermined value is a value (=“ALL F”) which sets all bits to “1”. Note that the predetermined value that is set in the check code is a value from which the external apparatus 2 may detect that the check code corresponds to a storage area where no data is written.

Thus, when the external apparatus 2 and the storage device 3 share common check codes, the storage control apparatus 1 does not need to determine for the first storage area whether data is written, on a per predetermined area basis. Accordingly, the storage control apparatus 1 is able to prevent a reduction in the reading performance due to the overhead of responding to a command.

### (b) Second Embodiment

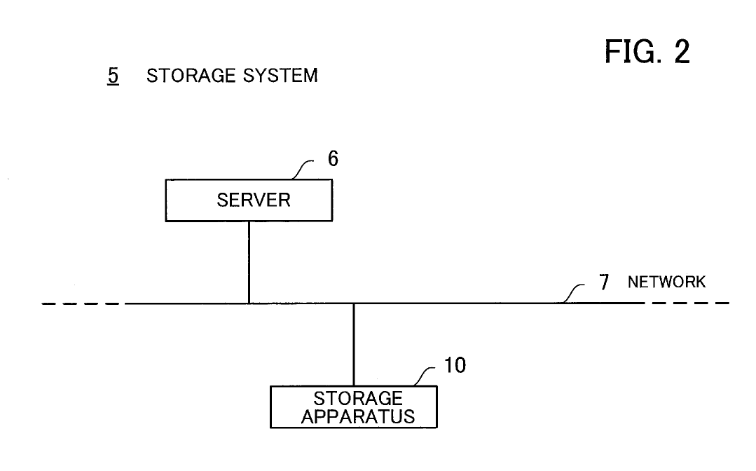

Next, the configuration of a storage system 5 of a second embodiment will be described with reference to FIG. 2. FIG. 2 illustrates an example of the configuration of the storage system 5 according to the second embodiment.

The storage system 5 includes a server 6, a network (transmission line) 7, and a storage apparatus 10. The network 7 connects, for example, at least one storage apparatus 10 and at least one server 6 to each other. The storage apparatus 10 is connected to the server 6 for communication therewith through the network 7. The server 6 is able to write data to the storage apparatus 10, and read data from the storage apparatus 10. The server 6 is one form of the external apparatus 2 of the first embodiment.

The storage apparatus 10 and the server 6 support the T10-DIF function. The storage apparatus 10 is able to set information indicating whether the T10-DIF function is supported in the volume attribute. The storage apparatus 10 and the server 6 are able to switch between an operation supported by the T10-DIF function and an operation not supported by the T10-DIF function, on a per-volume basis, by referring to the volume attribute.

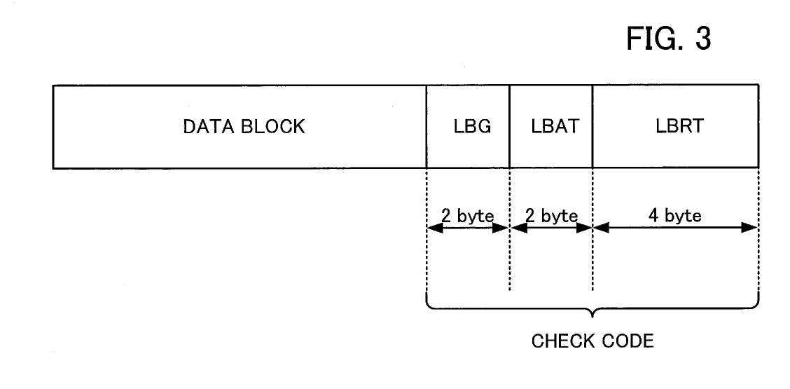

Now, the data structure supported by the T10-DIF function will be described with reference to FIG. 3. FIG. 3 illustrates an example of the data structure supported by the T10-DIF function according to the second embodiment.

The T10-DIF function is a standard for protecting user data by adding a check code called protection information (PI), and is often called T10-PI.

The data structure supported by the T10-DIF function is a data structure at the level of LBAs, each including a data block and a check code. The data block is an area capable of storing user data, and has a size of, for example, 512 bytes. The check code includes, for example, a 2-byte logical block guard (LBG), a 2-byte logical block application tag (LBAT), and a 4-byte logical block reference tag (LBRT). The LBG is a code for detecting an error in the data block, and is a cyclic redundancy check (CRC), for example. The LBAT is data defined by an application, and indicates that there is a designated application for the data block. The LBRT is data indicating the location to be referred to, and includes a part of the LBA for detecting whether data is written in a wrong location, for example.

In order to support the T10-DIF function, the storage apparatus 10 adds a common check code that is shared with the server 6, on a per-LBA basis. The storage apparatus 10 returns, for a written area where data is written, a check code that is written together with the data, to the server 6. On the other hand, the storage apparatus 10 returns, for an unwritten area where no data is written, a check code in which “ALL F” is set, to the server 6. In this step, the storage apparatus 10 needs to determine whether the area is a written area or an unwritten area on a per-LBA basis.

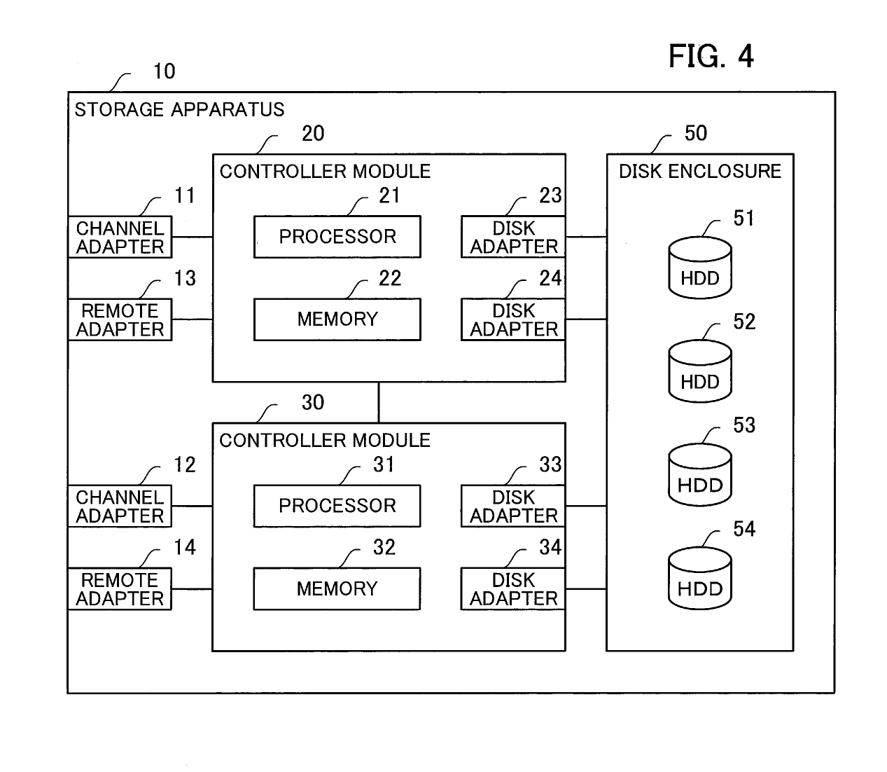

Next, the storage apparatus 10 according to the second embodiment will be described with reference to FIG. 4. FIG. 4 illustrates an example of the configuration of the storage apparatus 10 according to the second embodiment.

The storage apparatus 10 includes channel adapters 11 and 12, remote adapters 13 and 14, controller modules (CMs) 20 and 30, and a disk enclosure (DE) 50.

The storage apparatus 10 is connected to the server 6 via the channel adapters 11 and 12. The channel adapter 11 is provided to correspond to the controller module 20, while the channel adapter 12 is provided to correspond to the controller module 30. The storage apparatus 10 is connectable to other storage apparatuses via the remote adapters 13 and 14. The remote adapter 13 is provided to correspond to the controller module 20, while the remote adapter 14 is provided to correspond to the controller module 30.

The disk enclosure 50 includes HDDs 51, 52, 53, and 54. Note that the disk enclosure 50 may include other types of storage devices such as SSD and the like.

The controller module 20 and the controller module 30 are able to connect to each other so as to share the workload. Note that although the storage apparatus 10 includes two controller modules 20 and 30, the storage apparatus 10 may include either one of the controller module 20 and the controller module 30, or may include three or more, for example four or eight, controller modules.

The controller module 20 includes a processor 21, a memory 22, and disk adapters 23 and 24. The controller module 30 includes a processor 31, a memory 32, and disk adapters 33 and 34. Note that the controller module 30 has the same configuration as the controller module 20, and therefore the description below of the controller module 20 applies to the controller module 30 as well.

The processor 21, the memory 22, and the disk adapters 23 and 24 are connected to each other via a bus (not illustrated). The processor 21 controls the entire controller module 20, and performs storage control including hierarchical control. Note that the processor 21 may be a multiprocessor. The processor 21 may be, for example, a central processing unit (CPU), a micro processing unit (MPU), a digital signal processor (DSP), an application specific integrated circuit (ASIC), or a programmable logic device (PLD). Alternatively, the processor 21 may be a combination of two or more of the devices selected from CPU, MPU, DSP, ASIC, and PLD.

The memory 22 holds data read from the HDDs 51, 52, 53, and 54, and serves as a buffer when writing data to the HDDs 51, 52, 53, and 54. Further, the memory 22 stores user data and control information.

The memory 22 includes a RAM and a non-volatile memory, for example. The RAM serves as a primary storage device of the controller module 20. The RAM temporarily stores at least part of an operating system program, firmware, and application programs that are executed by the processor 21. The RAM also stores various types of data that are used for processing by the processor 21. The RAM may include a cache memory, separately from a memory for storing various types of data.

The non-volatile memory retains stored data even when power of the storage apparatus 10 is removed. Examples of the non-volatile memory include semiconductor memory device (such as electrically erasable and programmable ROM (EEPROM), flash memory, and the like), HDD, and so on. The non-volatile memory serves as a secondary storage device of the controller module 20. The non-volatile memory stores the operating system program, firmware, application programs, and various types of data.

Examples of peripheral devices connected to the bus include an input and output interface and a communication interface. The input and output interface is connected to an input and output device so as to perform input and output operations. The input and output interface transmits signals and data transmitted from storage devices, such as the HDDs and the like, to the processor 21 and the memory 22. Further, the input and output interface outputs signals received from the processor 21, to other control units and output devices connected to the controller module 20. The communication interface transmits data to and receives data from the other controller module (controller module 30) in the storage apparatus 10.

The disk adapters 23 and 24 perform interface control (access control) for the HDDs 51, 52, 53, and 54.

With the hardware configuration described above, it is possible to realize the processing functions of the storage apparatus 10 or the controller modules 20 and 30. Note that the storage control apparatus 1 of the first embodiment may be realized with a hardware configuration similar to that of the storage apparatus 10 or that of the controller modules 20 and 30.

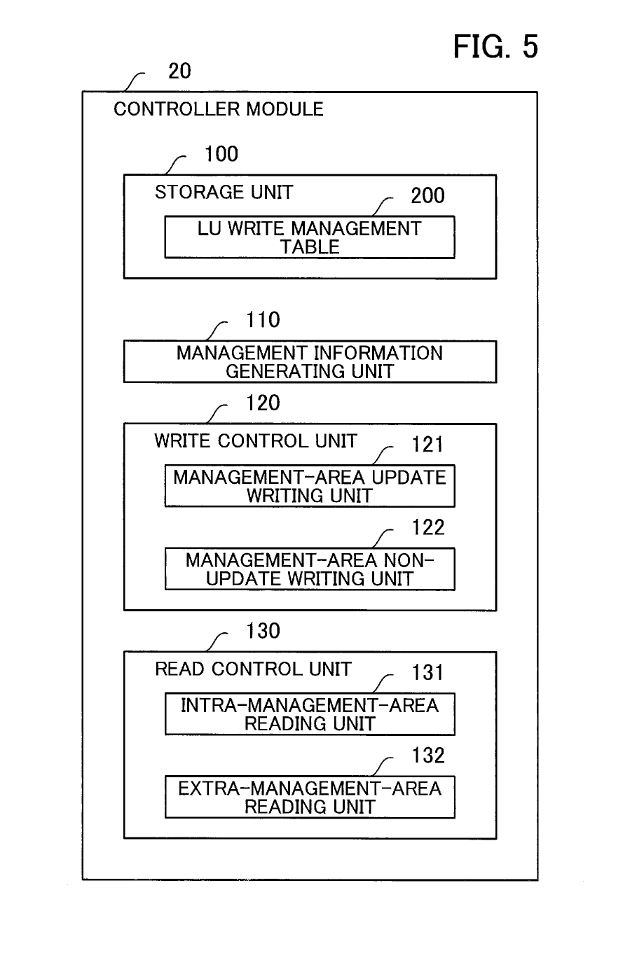

Next, the configuration of the processing functions of the controller module 20 will be described with reference to FIG. 5. FIG. 5 is a block diagram illustrating an example of the configuration of the processing functions of the controller module 20 according to the second embodiment.

The controller module 20 includes a storage unit 100, a management information generating unit 110, a write control unit 120, and a read control unit 130. The controller module 20 is one form of a storage control apparatus. The management information generating unit 110, the write control unit 120, and the read control unit 130 are realized when, for example, the processor 21 of the controller module 20 executes a predetermined program. The storage unit 100 stores a logical unit (LU) write management table 200. The storage unit 100 is realized by, for example, a predetermined storage area of the memory 22 of the controller module 20.

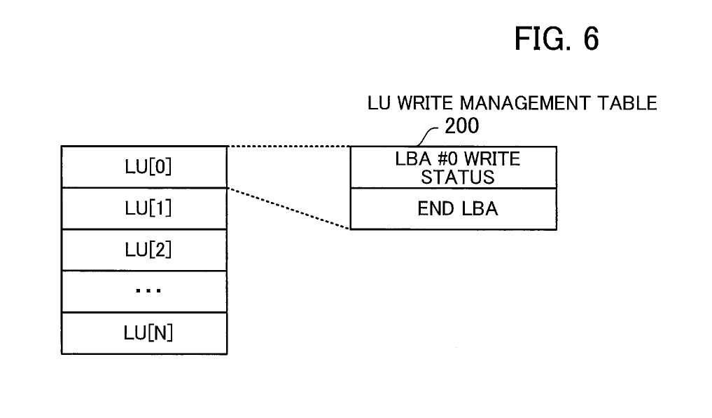

Now, the data structure of the LU write management table 200 will be described with reference to FIG. 6. FIG. 6 illustrates an example of the data structure of the LU write management table 200 according to the second embodiment.

The LU write management table 200 is information for managing whether data is written in a management area in each LU (volume). The management area is a written area continuous from the start LBA of each LU, and is one form of the first storage area in the first embodiment.

The LU write management table 200 includes an LBA #0 write status and an end LBA of each of LU[0] (LU identified by logical unit number (LUN)=“0”) through LU[N]. FIG. 6 illustrates the LBA #0 write status and the end LBA. The LBA #0 write status and the end LBA of each of LU[1] through LU[N] are omitted in FIG. 6.

The LBA #0 write status indicates whether data is written in the LBA #0 of the current LU. For example, if the LBA #0 write status of LU[0]=“0”, this indicates that LBA #0 is an unwritten area where data is not yet written. On the other hand, if the LBA #0 write status of LU[0]=“1”, this indicates that LBA #0 is a written area where data is already written. Note that LBA #0 is an example of the start LBA of a user area.

The end LBA represents the end address of a written area continuous from the LBA #0 in the current LU. For example, if the end address LBA=“LBA #100”, this indicates that, in the current LU, a written area is continuous from LBA #0 to LBA #100, and LBA #101 is an unwritten area.

Referring back to FIG. 5, the configuration of the processing functions of the controller module 20 will be further described. When configuring an LU, the management information generating unit 110 registers an LBA #0 write status and an end LBA corresponding to the configured LU. Further, when formatting an LU, the management information generating unit 110 initializes an LBA #0 write status and an end LBA corresponding to the formatted LU.

The write control unit 120 performs write control corresponding to a WRITE command received from the server 6. The write control unit 120 includes a management-area update writing unit 121 and a management-area non-update writing unit 122.

The management-area update writing unit 121 performs management-area update writing which is a data writing operation involving updating of the management area. The management-area non-update writing unit 122 performs management-area non-update writing which is a data writing operation not involving updating of the management area. The management-area update writing is writing in the case where the end LBA of the management area is included in the range of the write area. The management-area non-update writing is writing in the case where the end LBA of the management area is not included in the range of the write area.

The read control unit 130 performs read control corresponding to a READ command received from the server 6. The read control unit 130 includes an intra-management-area reading unit 131 and an extra-management-area reading unit 132. The intra-management-area reading unit 131 performs intra-management-area reading which is an operation of reading data from inside the management area. The extra-management-area reading unit 132 performs extra-management-area reading which is an operation of reading data from outside the management area.

In the intra-management-area reading, since the range inside the management area is a written area, there is no need to determine whether the area is a written area or an unwritten area on a per-LBA basis. On the other hand, in the extra-management-area reading, the storage apparatus 10 needs to determine whether the area is a written area or an unwritten area on a per-LBA basis.

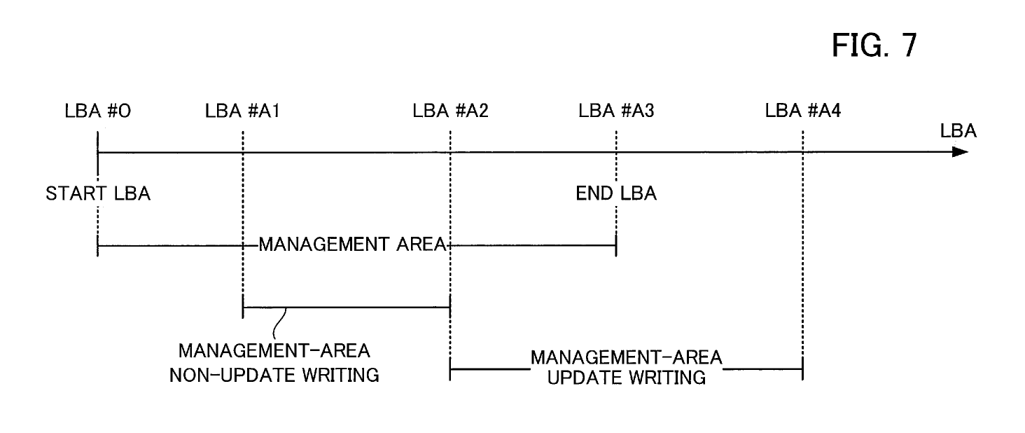

Now, management-area update writing and management-area non-update writing will be described with reference to FIG. 7. FIG. 7 illustrates an example of management-area update writing and management-area non-update writing according to the second embodiment.

In FIG. 7, a management area whose start LBA is LBA #0 and whose end LBA is LBA #A3 is set. Writing to a continuous storage area from LBA #A1 to LBA #A2 is the management-area non-update writing, because the end LBA (LBA #A3) of the management area is not included in the range of the write area. Although not illustrated, writing to a continuous storage area from a location ahead of LBA #A3 (for example, a continuous storage area from LBA #4) is also the management-area non-update writing, because the end LBA (LBA #A3) of the management area is not included in the range of the write area.

On the other hand, writing to a continuous storage area from LBA #A2 to LBA #A4 is the management-area update writing, because the end LBA (LBA #A3) of the management area is included in the range of the write area. By performing management-area update writing, the management-area update writing unit 121 updates the end LBA from LBA #A3 to LBA #A4 and thus expands the range of the management area.

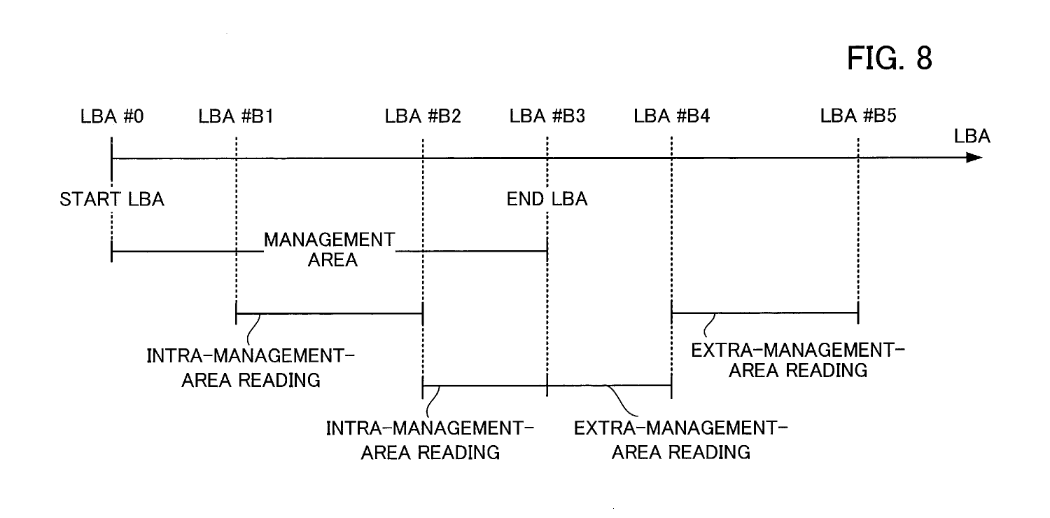

Next, intra-management-area reading and extra-management-area reading will be described with reference to FIG. 8. FIG. 8 illustrates an example of intra-management-area reading and extra-management-area reading according to the second embodiment.

In FIG. 8, a management area whose start LBA is LBA #0 and whose end LBA is LBA #B3 is set. Reading from a continuous storage area from LBA #B1 to LBA #B2 is the intra-management-area reading, because the storage area is within the range of the management area. On the other hand, reading from a continuous storage area from LBA #B4 to LBA #B5 is the extra-management-area reading, because the storage area is outside the range of the management area.

Further, in the case where the end LBA is included in the read target storage area, reading of the read target storage area may be divided by the end LBA into intra-management-area reading and extra-management-area reading. For example, a continuous storage area from LBA #B2 to LBA #B4 includes the end LBA (LBA #B3). Therefore, reading from the storage area LBA #B2 to LBA #B3 may be intra-management-area reading, and reading from the storage area LBA #B3 to LBA #B4 may be extra-management-area reading.

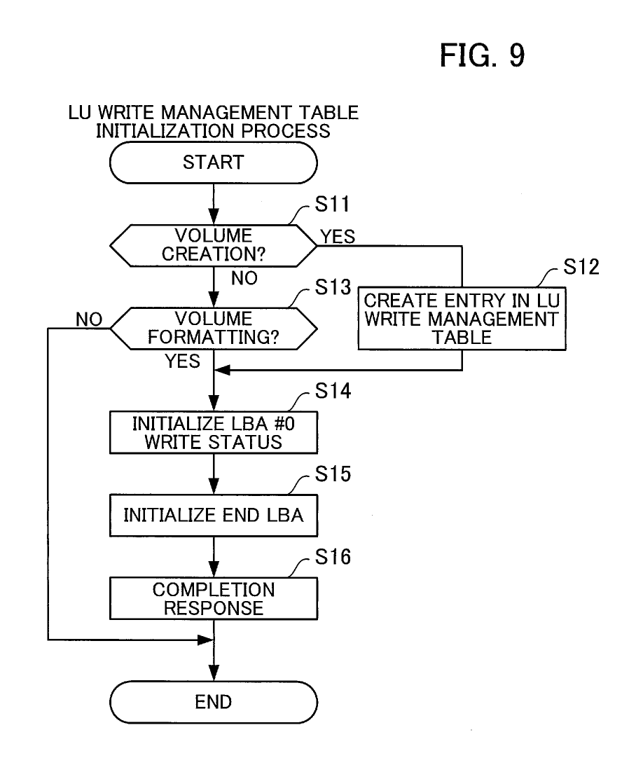

Next, an LU write management table initialization process according to the second embodiment will be described with reference to FIG. 9. FIG. 9 is a flowchart of an LU write management table initialization process according to the second embodiment.

The LUN write management table initialization process is a process that initializes the LU write management table 200 on a per-volume (logical unit (LU)) basis. The LU write management table initialization process is executed by the management information generating unit 110, in response to receiving a volume-related operation (volume operation) from the server 6.

(Step S11) The management information generating unit 110 determines whether the volume operation is creation of a volume. If the management information generating unit 110 determines that the volume operation is creation of a volume, the process proceeds to step S12. On the other hand, if the management information generating unit 110 determines that the volume operation is not creation of a volume, the process proceeds to step S13.

(Step S12) The management information generating unit 110 generates an entry for a created volume in the LU write management table 200.

(Step S13) The management information generating unit 110 determines whether the volume operation is formatting of a volume. If the management information generating unit 110 determines that the volume operation is formatting of a volume, the process proceeds to step S14. On the other hand, if the management information generating unit 110 determines that the volume operation is not formatting of a volume, the LU write management table initialization process ends.

(Step S14) The management information generating unit 110 initializes the LBA #0 write status of the operation target volume. For example, the management information generating unit 110 sets the LBA #0 write status of the operation target volume to “0” indicating that LBA #0 is an unwritten area.

(Step S15) The management information generating unit 110 initializes the end LBA of the operation target volume. For example, the management information generating unit 110 sets the end LBA of the operation target volume to “0” indicating that the end LBA is not yet set. Note that if the LBA #0 write status is initialized, the end LBA may be treated as “don't care”.

(Step S16) The management information generating unit 110 returns to the server 6 a completion response to the received volume operation.

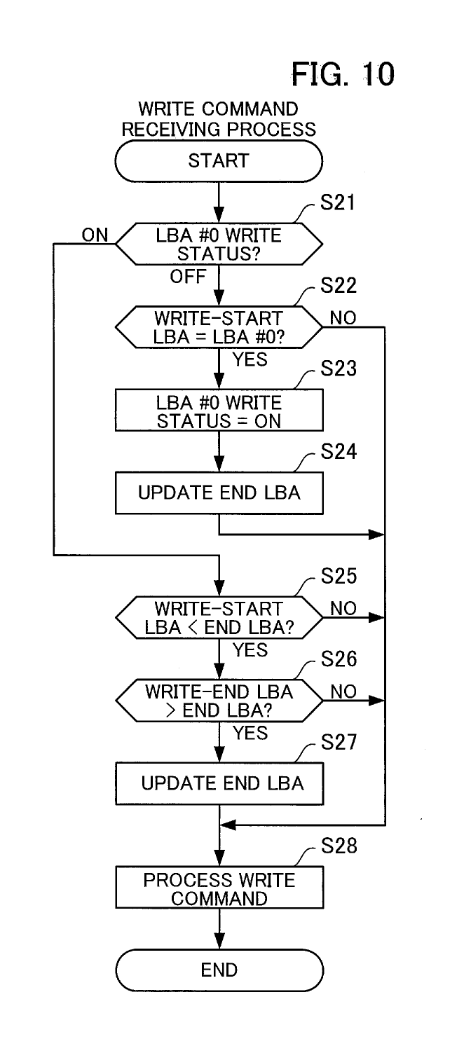

Next, a WRITE command receiving process according to the second embodiment will be described with reference to FIG. 10. FIG. 10 is a flowchart of a WRITE command receiving process according to the second embodiment.

The WRITE command receiving process is executed by the write control unit 120, in response to receiving a WRITE command from the server 6. The WRITE command receiving process is a process that returns to the server 6 a response to the received WRITE command, and updates the LU write management table 200 based on a write target area.

(Step S21) The write control unit 120 determines an LBA #0 write status of a write target volume, by referring to the LU write management table 200. If the write control unit 120 determines that the LBA #0 write status of the write target volume is ON (=“1”), the process proceeds to step S25. On the other hand, if the write control unit 120 determines that the LBA #0 write status of the write target volume is OFF (=“0”), the process proceeds to step S22.

(Step S22) The write control unit 120 determines whether a write-start LBA (a start address of the write target area) is LBA #0 (a start address of the write target volume). If the write control unit 120 determines that the write-start LBA is LBA #0, the process proceeds to step S23. On the other hand, if the write control unit 120 determines that the write-start LBA is not LBA #0, the process proceeds to step S28.

(Step S23) Since a storage area including LBA #0 of the write target volume is the write target, the write control unit 120 sets the LBA #0 write status of the write target volume to ON. The write control unit 120 updates the LU write management table 200 in accordance with the setting change.

(Step S24) The write control unit 120 updates an end LBA of the write target volume with an end address of the write target storage area. The write control unit 120 updates the LU write management table 200 in accordance with the updated end LBA.

(Step S25) The write control unit 120 determines whether a write-start LBA (a start address of the write target storage area) is smaller than the end LBA. That is, the write control unit 120 determines whether the write-start LBA is within the management area (see FIG. 7). If the write control unit 120 determines that the write-start LBA is less than the end LBA, the process proceeds to step S26. On the other hand, if the write control unit 120 determines that the write-start LBA is not less than the end LBA, the process proceeds to step S28.

(Step S26) The write control unit 120 determines whether a write-end LBA (the end address of the write target storage area) is greater than the end LBA. That is, the write control unit 120 determines whether the write-end LBA is outside the management area. If the write control unit 120 determines that the write-end LBA is greater than the end LBA, the process proceeds to step S27. On the other hand, if the write control unit 120 determines that the write-end LBA is not greater than the end LBA, the process proceeds to step S28.

(Step S27) The write control unit 120 updates the end LBA with the write-end LBA. That is, the write control unit 120 determines whether writing in accordance with the WRITE command is management area update writing in steps S25 and S26, and updates the end LBA if the writing in accordance with the WRITE command is management-area update writing.

(Step S28) The write control unit 120 executes an operation (for example, writing data to a write target area and returning to the server 6 the data write result) corresponding to the WRITE command. Then, the WRITE command receiving process ends.

In the manner described above, the write control unit 120 realizes the management-area update writing described with reference to FIG. 7, by performing WRITE command processing (step S28) that involves end LBA updating (step S27). In this case, the write control unit 120 serves as the management-area update writing unit 121. Further, the write control unit 120 realizes the management-area non-update writing described with reference to FIG. 7, by performing WRITE command processing (step S28) that does not involve end LBA updating (step S27). In this case, the write control unit 120 serves as the management-area non-update writing unit 122.

Note that, according to one aspect, the write control unit 120 serves as a management information update unit that updates management information on each write target volume managed by the LU write management table 200, by executing a WRITE command receiving process.

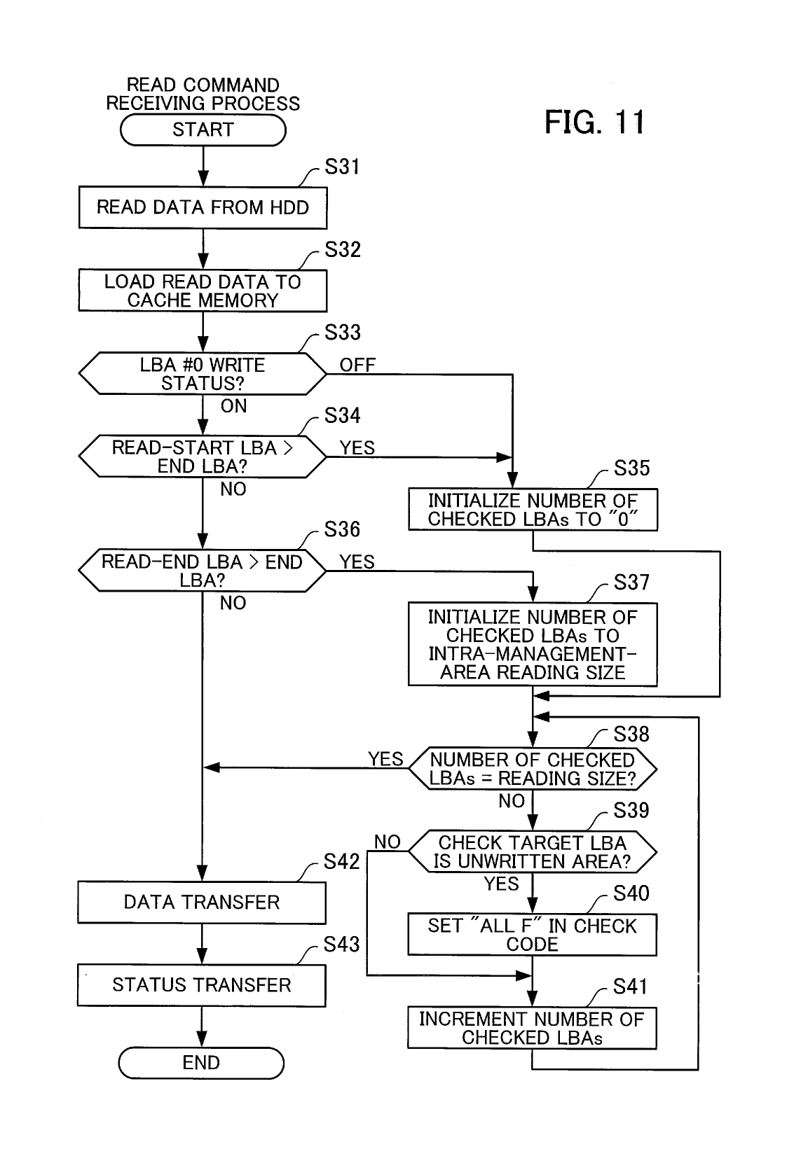

Next, a READ command receiving process according to the second embodiment will be described with reference to FIG. 11. FIG. 11 is a flowchart of a READ command receiving process according to the second embodiment.

The READ command receiving process is executed by the read control unit 130, in response to receiving a READ command from the server 6. The READ command receiving process is a process that sets “ALL F” in an unwritten area, and returns to the server 6 a response to the received READ command.

(Step S31) In response to a READ command, the read control unit 130 reads data from any of the HDDs 51, 52, 53, and 54.

(Step S32) The read control unit 130 loads the read data to the cache memory.

(Step S33) The read control unit 130 determines an LBA #0 write status of a read target volume, by referring to the LU write management table 200. If the read control unit 130 determines that the LBA #0 write status of the read target volume is ON, the process proceeds to step S34. On the other hand, if the read control unit 130 determines that the LBA #0 write status of the read target volume is OFF, the process proceeds to step S35.

(Step S34) The read control unit 130 determines whether a read-start LBA (a start address of a read target storage area) is greater than the end LBA. That is, the read control unit 130 determines whether the read-start LBA is outside the management area (see FIG. 8). If the read control unit 130 determines that the read-start LBA is greater than the end LBA, the process proceeds to step S35. On the other hand, if the read control unit 130 determines that the read-start LBA is not greater than the end LBA, the process proceeds to step S36. The case where the read-start LBA is greater than the end LBA corresponds to, for example, the case where reading from the range from LBA #B4 to LBA #B5 is performed as illustrated in FIG. 8.

(Step S35) When the LBA #0 write status is OFF and the read-start LBA is outside the management area, the read control unit 130 initializes the number of checked LBAs to “0”. The number of checked LBAs is a counter for managing the progress in determining whether the read target area is an unwritten area on a per-LBA basis.

(Step S36) The read control unit 130 determines whether a read-end LBA (an end address of the read target storage area) is greater than the end LBA. That is, the read control unit 130 determines whether the read-end LBA is outside the management area. If the read control unit 130 determines that the read-end LBA is greater than the end LBA, the process proceeds to step S37. On the other hand, if the read control unit 130 determines that the read-end LBA is not greater than the end LBA, the process proceeds to step S42. The case where the read-end LBA is greater than the end LBA corresponds to, for example, the case where reading from the range from LBA #B2 to LBA #B4 is performed as illustrated in FIG. 8.

(Step S37) The read control unit 130 initializes the number of checked LBAs to an intra-management-area reading size. The intra-management-area reading size indicates the number of LBAs of a storage area where a management area and a read area overlap, and may be calculated by read-end LBA−end LBA. By setting the intra-management-area reading size as the initial value of the number of checked LBAs, the read control unit 130 limits the area for which a determination of whether the area is an unwritten area is made to a part of the read target area. This is because the management area is a written area and may be excluded from the area for which such a determination is made.

(Step S38) The read control unit 130 determines whether the number of checked LBAs is equal to the reading size (the number of LBAs of the read target storage area). If the read control unit 130 determines that the number of checked LBAs is equal to the reading size, the process proceeds to step S42. On the other hand, if the read control unit 130 determines that the number of checked LBAs is not equal to the reading size, the process proceeds to step S39.

(Step S39) The read control unit 130 determines whether a check target LBA is an unwritten area. For example, the read control unit 130 determines whether the check target LBA is an unwritten area, by referring to metadata. If the read control unit 130 determines that the check target LBA is an unwritten area, the process proceeds to step S40. On the other hand, if the read control unit 130 determines that the check target LBA is not an unwritten area, the process proceeds to step S41. Note that the check target LBA is an LBA determined by adding the number of checked LBAs to the read-start LBA.

(Step S40) The read control unit 130 sets “ALL F” in a check code of the check target LBA, among the read data loaded in the cache memory. Thus, the read control unit 130 is able to set a check code to the check target LBA at a high speed.

(Step S41) The read control unit 130 increments the number of checked LBAs.

(Step S42) The read control unit 130 performs data transfer corresponding to the READ command.

(Step S43) The read control unit 130 performs status transfer corresponding to the READ command. Thus, the READ command receiving process ends.

In the manner described above, the read control unit 130 realizes the intra-management-area reading described with reference to FIG. 8, by performing data transfer processing (step S42) that does not involve determining whether an LBA is an unwritten area. In this case, the read control unit 130 serves as the intra-management-area reading unit 131. Further, the read control unit 130 realizes the extra-management-area reading described with reference to FIG. 8, by performing data transfer processing (step S42) that involves determining whether an LBA is an unwritten area (step S39). In this case, the read control unit 130 serves as the extra-management-area reading unit 132.

Note that, according to one aspect, the write control unit 120 serves as a check code conversion location determination unit that determines a check code conversion location, by performing operations of steps S33 through S37.

Thus, the read control unit 130 does not need to determine, for a part of the read target storage area overlapping the management area, whether that part is an unwritten area. Thus, when the read target storage area is within the management area, the read control unit 130 is able to achieve the same level of reading performance as that achieved in the case of a volume not using the T10-DIF function. Further, when even only a part of the read target storage area is included in the management area, the read control unit 130 is able to reduce the overhead of determining whether the storage area is an unwritten area. Accordingly, the storage apparatus 10 is able to prevent a reduction in the reading performance due to the overhead of responding to a command.

Note that since the management information generating unit 110 is able to control the size of the LU write management table 200 (management information) in accordance with the number of volumes, regardless of the size of each volume, it is possible to reduce the size of the storage area needed for management. For example, the management information generating unit 110 needs to allocate only 9 bytes (=LBA (8 bytes)+LBA # write status (1 byte)) to each LU for management information. That is, only 900 bytes are needed to manage 100 volumes of 100 GB.

Note that in the case of managing each block using a 1-bit bitmap instead of using such management information, when the block size is 512 bytes, the size of the storage area needed for managing a 1-GB volume is 256 KB, and the size of the storage area needed for managing 100 volumes is as large as 2,500 MB.

Accordingly, the storage apparatus 10 is able to prevent a reduction in the reading performance due to the overhead of responding to a command, while reducing the size of the storage area needed for management.

The above-described processing functions may be implemented by a computer. In this case, a program describing operations of the functions of the storage control apparatus 1, the storage apparatus 10, and the controller modules 20 and 30 is provided. When the program is executed by a computer, the above-described processing functions are implemented on the computer. The program describing operations of the functions may be stored in a computer-readable storage medium. Examples of computer-readable storage media include magnetic storage devices, optical discs, magneto-optical storage media, semiconductor memory devices, and the like. Examples of magnetic storage devices include hard disk drive (HDD), flexible disk (FD), magnetic tapes, and the like. Examples of optical discs include digital versatile disk (DVD), DVD-RAM, CD-ROM, CD-RW, and the like. Examples of magneto-optical storage media include magneto-optical disk (MO) and the like.

For distributing the program, the program may be stored and sold in the form of a portable storage medium such as DVD, CD-ROM, and the like, for example. The program may also be stored in a storage device of a server computer, and transmitted from the server computer to other computers via a network.

For executing the program on a computer, the computer stores the program recorded in the portable storage medium or the program transmitted from the server computer in its storage device. Then, the computer reads the program from its storage device, and performs processing in accordance with the program. The computer may read the program directly from the portable storage medium, and execute processing in accordance with the program. Further, the computer may sequentially receive the program from a server computer connected over a network, and perform processing in accordance with the received program.

The above-described processing functions may also be implemented wholly or partly by using electronic circuits such as DSP, ASIC, PLD, and the like.

According to one aspect, a storage control apparatus, a storage control program, and a storage control method are capable of preventing a reduction in the reading performance due to the overhead in responding to a command.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus that controls access to a predetermined storage area in a storage device, the storage control apparatus comprising:
a memory configured to store management information for managing whether data is written in a first storage area, the first storage area being continuous from a start address of a logical volume; and
a processor configured to perform a procedure including:
when writing write target data and a check code corresponding to the write target data to a second storage area in units of predetermined areas, the second storage area being continuous and including an address next to an end address of the first storage area specified based on the management information, updating the management information such that the first storage area includes the second storage area by changing the end address of the first storage area to an end address of the second storage area,
when reading read target data from inside the first storage area specified based on the management information, reading a check code corresponding to the read target data, together with the read target data, and
when reading read target data from outside the first storage area specified based on the management information, determining on a per predetermined area basis whether data is written, reading a check code corresponding to the read target data, together with the read target data, from a storage area where data is written, and setting a predetermined value in a check code corresponding to a storage area where no data is written.

2. The storage control apparatus according to claim 1, wherein:
the management information includes the end address of the first storage area; and
the procedure further includes, when configuring the logical volume or when formatting the logical volume, initializing the end address of the first storage area to the start address of the logical volume.

3. The storage control apparatus according to claim 2, wherein:
the management information includes data write information indicating whether data is written at the start address of the logical volume; and
the procedure further includes, when data is written to a continuous storage area including the start address while the data write information indicates that no data is written at the start address, updating the data write information such that the data write information indicates that data is written at the start address, and changing the end address of the first storage area to an end address of the continuous storage area including the start address.

4. The storage control apparatus according to claim 1, wherein the procedure further includes setting the predetermined value in a check code that is read from the storage device and loaded into a cache memory.

5. A non-transitory computer-readable storage medium storing a computer program that causes a computer to perform a procedure for performing storage control that controls access to a predetermined area in a storage device, the procedure comprising:
obtaining, from a storage unit, management information for managing whether data is written in a first storage area, the first storage area being continuous from a start address of a logical volume;
when writing write target data and a check code corresponding to the write target data to a second storage area in units of predetermined areas, the second storage area being continuous and including an address next to an end address of the first storage area specified based on the management information, updating the management information such that the first storage area includes the second storage area by changing the end address of the first storage area to an end address of the second storage area;
when reading read target data from inside the first storage area specified based on the management information, reading a check code corresponding to the read target data, together with the read target data; and
when reading read target data from outside the first storage area specified based on the management information, determining on a per predetermined area basis whether data is written, reading a check code corresponding to the read target data, together with the read target data, from a storage area where data is written, and setting a predetermined value in a check code corresponding to a storage area where no data is written.

6. The non-transitory computer-readable storage medium according to claim 5, wherein:
the management information includes the end address of the first storage area; and
the procedure further includes, when configuring the logical volume or when formatting the logical volume, initializing the end address of the first storage area to the start address of the logical volume.

7. The non-transitory computer-readable storage medium according to claim 6, wherein:
the management information includes data write information indicating whether data is written at the start address of the logical volume; and
the procedure further includes, when data is written to a continuous storage area including the start address while the data write information indicates that no data is written at the start address, updating the data write information such that the data write information indicates that data is written at the start address, and changing the end address of the first storage area to an end address of the continuous storage area including the start address.

8. The non-transitory computer-readable storage medium according to claim 5, wherein the procedure further includes setting the predetermined value in a check code that is read from the storage device and loaded into a cache memory.

9. A storage control method that controls access to a predetermined storage area in a storage device, the storage control method comprising:
obtaining, by a processor, from a storage unit, management information for managing whether data is written in a first storage area, the first storage area being continuous from a start address of a logical volume;
when writing write target data and a check code corresponding to the write target data to a second storage area in units of predetermined areas, the second storage area being continuous and including an address next to an end address of the first storage area specified based on the management information, updating, by the processor, the management information such that the first storage area includes the second storage area by changing the end address of the first storage area to an end address of the second storage area;
when reading read target data from inside the first storage area specified based on the management information, reading, by the processor, a check code corresponding to the read target data, together with the read target data; and
when reading read target data from outside the first storage area specified based on the management information, determining, by the processor, on a per predetermined area basis whether data is written, reading a check code corresponding to the read target data, together with the read target data, from a storage area where data is written, and setting a predetermined value in a check code corresponding to a storage area where no data is written.

10. The storage control method according to claim 9, wherein:
the management information includes the end address of the first storage area; and
the method further includes, when configuring the logical volume or when formatting the logical volume, initializing, by the processor, the end address of the first storage area to the start address of the logical volume.

11. The storage control method according to claim 10, wherein:
the management information includes data write information indicating whether data is written at the start address of the logical volume; and
the storage control method further includes, when data is written to a continuous storage area including the start address while the data write information indicates that no data is written at the start address, updating, by the processor, the data write information such that the data write information indicates that data is written at the start address, and changing the end address of the first storage area to an end address of the continuous storage area including the start address.

12. The storage control method according to claim 9, further comprising setting, by the processor, the predetermined value in a check code that is read from the storage device and loaded into a cache memory.
